(19) United States
(12) Patent Application Publication
(10) Pub. No.: US 2017/0009425 A1
(43) Pub. Date: Jan. 12, 2017

(54) Cab Protection Device for Working Machine

(71) Applicant: CATERPILLAR SARL, Geneva (CH)

(72) Inventors: Hidenobu Tajima, Setagaya-ku, Tokyo (JP); Eiji Akahane, Setagaya-ku, Tokyo (JP); Takahiro Iwamoto, Setagaya-ku, Tokyo (JP)

(73) Assignee: Caterpillar SARL, Geneva (CH)

(21) Appl. No.: 15/118,020

(22) PCT Filed: Mar. 4, 2015
(86) PCT No.: PCT/EP2015/054487

§ 371 Date: Aug. 10, 2016

(30) Foreign Application Priority Data
Mar. 5, 2014 (JP) 2014-042610

(51) Int. Cl. E02F 9/16; B62D 33/06

(52) U.S. Cl. CPC E02F 9/166; E02F 9/163; B62D 33/0604

(57) ABSTRACT

A regulation device including a stopper receiving part mounted on the machine frame and/or the bottom of the cab includes a through hole formed at the center part, a shaft penetrating the through hole of the stopper receiving part and a stopper supported by the shaft. A spherical surface is formed on the side surface of a stopper where a stopper receiving part contacts. When the cab displaces in the direction away from the machine frame, the spherical surface of the stopper contacts in vicinity of a through hole of the receiving part to inhibit detachment.

### TECHNICAL FIELD

The present invention relates to a technical field of a cab protection device for a working machine such as an excavator including a cab.

### BACKGROUND ART

In general, a working machine such as an excavator which has a cab which serves as an operator's cabin is known. When the cab is mounted on a body, the cab is attached and supported on a body frame with an antivibration mount interposed so as to reduce vibration and noise transmitted from the body to the cab. In such a working machine, it is necessary to prevent the antivibration mount from being broken and the cab from being removed from the body frame, for example, when the body rolls over. Thus, conventionally, techniques of providing a restricting device near the antivibration mount so as to restrict the cab from being displaced in a direction away from the body frame are known (for example, see Patent Literatures 1 and 2). In these conventional techniques, the restricting device is formed using a stopper receiver formed in a body frame and having a through-hole formed at a center thereof, a shaft of which the upper part is fixed to the bottom of a cab and which passes through the through-hole of the stopper receiver, and a stopper supported on a lower part of the shaft, and the stopper has a disc shape having a larger diameter than the through-hole. When the cab is displaced in a direction away from the body frame, for example, when the body rolls over, the disc-shaped stopper is received in a state where the disc-shaped stopper makes contact with the peripheral portion of the through-hole of the stopper receiver. In this way, the cab can be prevented from being displaced in a direction away from the body frame.

Patent Literature 1: Japanese Patent Application Publication No. 2004-189089

Patent Literature 2: Japanese Patent Application Publication No. 2007-182698

### DISCLOSURE OF THE INVENTION

However, even when the cab is displaced in a direction away from the body frame, for example, when the body rolls over, the cab may not be displaced in a direction parallel to the body frame, but in many cases, the cab may be inclined with respect to the body frame. In the conventional restricting device, when the cab is displaced in an inclined state in this manner, the disc-shaped stopper makes biased contact with the stopper receiver on the peripheral side of the through-hole. However, in the restricting device of Patent Literature 2, although ribs are formed on a disc-shaped stopper, since the ribs are configured to be deformed to absorb impact when the ribs make contact with the stopper receiver, the ribs may not be able to prevent the stopper from making contact with the stopper receiver in a biased state. In such a biased contacting state, the contacting area between the stopper receiver and the stopper that receives the load of the cab decreases. If the contacting area between the stopper and the stopper receiver is too small, it is not possible to secure the strength required for receiving the load of the cab. Thus, it is necessary to increase the size of the disc-shaped stopper so as to secure the contacting area capable of securing the required strength in the biased state. As a result, the entire size of the restricting device also increases and flexibility in the arrangement location thereof decreases, which is disadvantageous in terms of cost and which is to be solved by the present invention.

The present invention has been invented in view of the foregoing with the aim to solve these problems. According to a first aspect of the present invention, there is provided a cab protection device for a working machine in which a cab is attached to and mounted on an upper side of a body frame, with an antivibration mount being interposed between the cab and the body frame, wherein a restricting device for restricting the cab from being displaced in a direction away from the body frame is formed with a stopper receiver which is provided on the body frame or/and a bottom of the cab and in which a through-hole is formed in a center thereof, a shaft that passes through the through-hole of the stopper receiver, and a stopper that is supported on the shaft so as to make contact with a peripheral portion of the through-hole of the stopper receiver in a locking manner to thereby restrict displacement of the cab when the cab is displaced in a direction away from the body frame, and a contacting surface of the stopper contacting the stopper receiver is formed as a spherical surface.

A second aspect of the present invention is the cab protection device for the working machine according to the first aspect, in which the stopper receiver is provided on the body frame, and the shaft has an upper part fixed to the bottom of the cab, an intermediate part that passes through the through-hole of the stopper receiver, and a lower part on which the stopper is supported.

A third aspect of the present invention is the cab protection device for the working machine according to the first aspect, in which the stopper receiver is provided on the bottom of the cab, and the shaft has a lower part fixed to the body frame, the intermediate part that passes through the through-hole of the stopper receiver, and an upper part on which the stopper is supported.

A fourth aspect of the present invention is the cab protection device for the working machine according to the first aspect, in which the stopper receiver is provided on the bottom of the cab and the body frame, with a cab-side stopper receiver and a body frame-side stopper receiver being faced with each other with a gap therebetween in an up-down direction, and the shaft has an intermediate part that passes through through-holes of the cab-side stopper receiver and the body frame-side stopper receiver, and upper and lower parts on which the stopper is supported.

With the first aspect of the present invention, it is possible to decrease the size of the stopper, to improve flexibility in an arrangement location of the restricting device, and to reduce the cost.

With the second aspect of the present invention, when the cab is displaced in a direction away from the body frame, the stopper provided on the lower part of the shaft makes contact, from the lower side, with the peripheral portion of the through-hole of the stopper receiver provided on the body frame in a locking manner, whereby the displacement of the cab is restricted.

With the third aspect of the present invention, when the cab is displaced in a direction away from the body frame, the stopper provided on the upper part of the shaft makes contact, from the upper side, with the peripheral portion of the through-hole of the stopper receiver provided on the bottom of the cab in a locking manner, whereby the displacement of the cab is restricted.

With the fourth aspect of the present invention, when the cab is displaced in a direction away from the body frame, the stoppers provided on the upper and lower parts of the shaft make contact, from the upper and lower sides, with the peripheral portion of the through-holes of the cab-side stopper receiver and the body frame-side stopper receiver provided on the bottom of the cab and the body frame, respectively, in a locking manner, whereby the displacement of the cab is restricted.

### BRIEF DESCRIPTION OF THE DRAWINGS

FIG. 1 is a perspective view of a swinging frame on which a cab is mounted.

FIG. 2 is a perspective view of a portion in which a restricting device and an antivibration mount are arranged.

FIG. 3A is a partial cross-sectional side view of a portion in which a restricting device and an antivibration mount are arranged and FIG. 3B is a plan view of a portion in which a restricting device is arranged.

FIG. 4A is a cross-sectional side view of a portion in which a restricting device is arranged according to a second embodiment and FIG. 4B is a cross-sectional side view of a portion in which a restricting device is arranged according to a third embodiment.

### BEST MODE FOR CARRYING OUT THE INVENTION

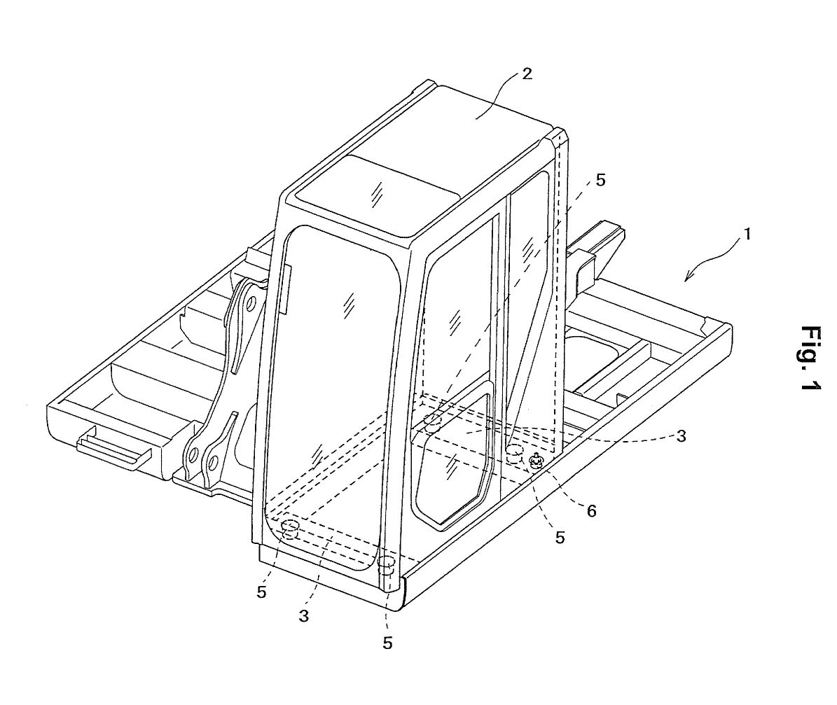

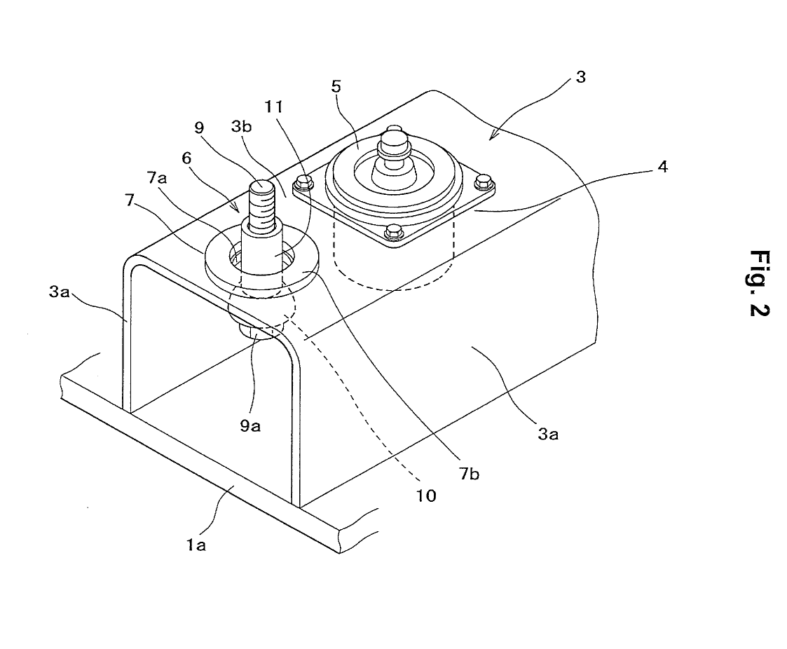

Hereinafter, a first embodiment of the present invention will be described based on FIG. 1 to FIGS. 3A and 3B. In these drawings, a swinging frame 1 (corresponding to a body frame of the present invention) serves as a frame of an upper swinging body of an excavator (an example of a working machine of the present invention), and a cab 2 is mounted on a front left portion of the swinging frame 1. Although not illustrated in the drawings, a base end of a front working unit is supported on a center in the left-right direction on the front side of the swinging frame 1 so as to freely swing in the up-down direction, a fuel tank, a hydraulic oil tank, an engine room, and the like are arranged in the front left portion and the rear side of the swinging frame 1, and a counterweight is attached to the rear end of the swinging frame 1.

Front and rear support frames 3 that face in the left-right direction are provided in the front and rear portions of a cab mounting portion of the swinging frame 1 in a state of being integrated with a bottom plate 1a of the swinging frame 1 by welding or the like. These front and rear support frames 3 are members in which a horizontal top plate 3b that faces in the left-right direction is integrated with vertical plates 3a erected from the bottom plate 1a of the swinging frame 1, and a mount attaching portion 4 is formed at both left and right ends of the top plate 3b of each support frame 3. Four antivibration mounts 5 in total for supporting the four corners of the cab 2 in a state where vibration is suppressed are attached to these mount attaching portions 4. The support frame 3 is a member that forms the swinging frame 1 and is included in the swinging frame 1. Moreover, in the present embodiment, a liquid sealed viscous mount is used as the antivibration mount 5. Since the structure of the liquid sealed viscous mount is well known, the description thereof will not be provided.

Further, a stopper receiver 7 that forms a restricting device 6 described later is provided in the left end of the top plate 3b of the rear-side support frame 3 in a state of being adjacent to the left side of the mount attaching portion 4 for the antivibration mount 5 that supports the left rear portion of the cab 2. The stopper receiver 7 has a through-hole 7a formed at the center thereof, and on the periphery of the through-hole 7a, a donut-shaped reinforcing plate 7b that is formed from a metal plate and is concentric to the through-hole 7a is integrally fixed to the top plate 3b by welding the entire circumference thereof.

The restricting device 6 is a device for restricting the cab 2 from being displaced in a direction away from the swinging frame 1. The restricting device 6 is formed using members such as the stopper receiver 7, a bolt (corresponding to a shaft of the present invention) 9 fixed to the bottom of the cab 2 with a cab-side supporting member 8 interposed (the cab-side supporting member 8 is a lower frame or a bottom plate of the cab 2 or is a member fixed to a lower frame or a bottom plate of the cab 2 by welding or the like, and in the present embodiment, is fixed to the bottom plate 2a of the cab 2 by welding), and a stopper 10 (described later) supported on the lower part of the bolt 9.

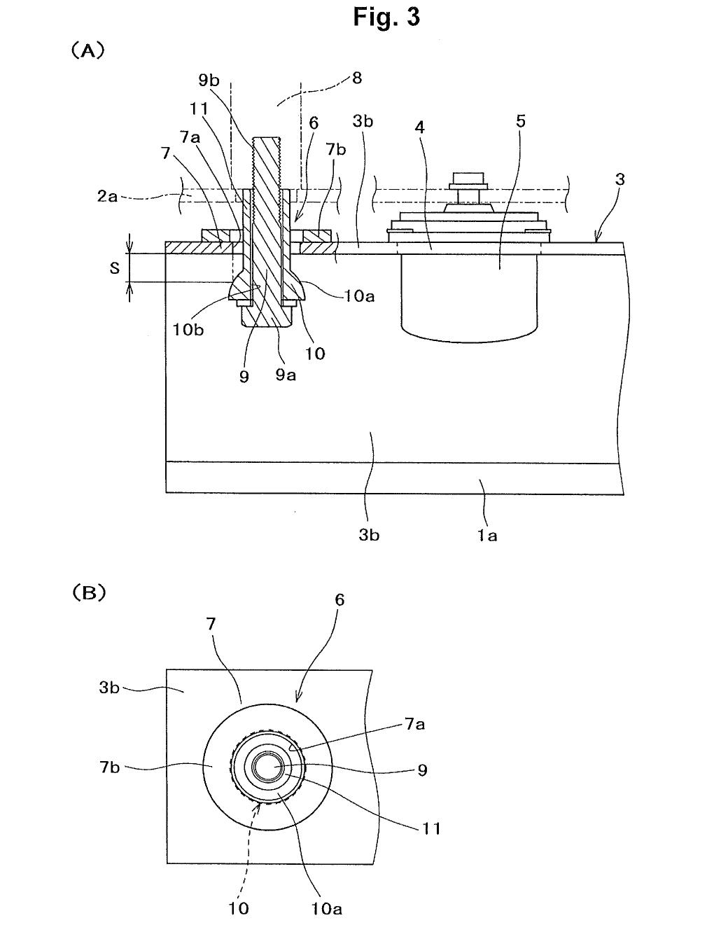

The stopper 10 has such a hemispherical trapezoidal shape that a spherical surface 10a which faces upward and a diameter of a lower surface is larger than that of the through-hole 7a of the stopper receiver 7, and a bolt insertion hole 10b through which the bolt 9 is inserted is formed in a shaft core thereof. Further, a cylindrical sleeve 11 is integrally formed on an upper surface of the stopper 10, an outer diameter of the sleeve 11 is set such that the sleeve 11 can loosely pass through the through-hole 7a of the stopper receiver 7, and an inner cylindrical portion of the sleeve 11 has the same center and the same diameter as those of the bolt insertion hole 10b of the stopper 10. The stopper 10 with which the sleeve 11 is integrated is supported on the lower part of the bolt 9, and the upper part of the bolt 9 is fixed to the cab-side supporting member 8. When the bolt 9 is fixed to the cab-side supporting member 8, first, the sleeve 11 on the upper side of the stopper 10 is inserted from the lower side so as to pass through the through-hole 7a of the stopper receiver 7. Subsequently, a thread portion 9b in the upper part of the bolt 9 inserted from the lower side into the bolt insertion hole 10b of the stopper 10 with a bolt head 9a positioned on the lower side is inserted so as to pass through the inner cylindrical portion of the sleeve 11 so as to be fastened into the cab-side supporting member 8 in a state where the upper end of the sleeve 11 inserted through the through-hole 7a is in contact with the lower surface of the cab-side supporting member 8. In this way, the upper part of the bolt 9 is fixed to the bottom of the cab 2 with the cab-side supporting member 8 interposed, an intermediate part of the bolt 9 passes through the through-hole 7a of the stopper receiver 7, and the stopper 10 is supported on the lower part of the bolt 9. Further, in this state, a gap S is formed between the lower surface of the stopper receiver 7 and a position at which an imaginary line drawn downward from the through-hole 7a reaches the spherical surface 10a of the stopper 10 (see FIG. 3A). The gap S is set as an allowable displacement amount of the cab 2 within such a range that the stopper 10 is separated from the stopper receiver 7 and the vibration suppressing function of the antivibration mount 5 is not impaired in a normal vibration state and that the antivibration mount 5 is not broken when the cab 2 is displaced in a direction away from the swinging frame 1 in the event of emergency such as rollover of the body. Thus, when the cab 2 is about to be displaced in a direction away from the swinging frame 1 exceeding an allowable displacement amount during a rollover of the body, the stopper 10 is received in a state where the stopper 10 makes contact with the stopper receiver 7 provided in the support frame 3 according to the displacement of the cab 2. As a result, the displacement of the cab 2 exceeding the allowable displacement amount is restricted and the displacement of the cab 2 is restricted before the antivibration mount 5 is broken. In this case, the load acting on the stopper receiver 7 from the stopper 10 when the cab 2 is about to be displaced by the allowable displacement amount or more is received by the support frame 3 and the reinforcing plate 7b. As a result, the stopper receiver 7 has a strong structure that can endure the load during a rollover of the body.

Further, as described above, the stopper 10 has such a hemispherical trapezoidal shape that a spherical surface 10a which faces upward and a diameter of a lower surface is larger than that of the through-hole 7a of the stopper receiver 7. When the cab 2 is about to be displaced in a direction away from the swinging frame 1 exceeding the allowable displacement amount, the stopper 10 is received in a state where the spherical surface 10a makes contact with the periphery of the through-hole 7a of the stopper receiver 7 in a locking manner. In this case, even when the cab 2 is displaced in a state of being inclined with respect to the swinging frame 1, the spherical surface 10a of the stopper 10 makes contact with the periphery of the through-hole 7a of the stopper receiver 7 without making biased contact. Due to this, even when the cab 2 is displaced in a state of being inclined with respect to the swinging frame 1, approximately the same contacting area as when the cab 2 is displaced in parallel with the swinging frame 1 can be secured between the stopper 10 and the stopper receiver 7.

In the first embodiment having such a configuration, the restricting device 6 for restricting the cab 2 from being displaced in a direction away from the swinging frame 1 is provided in an excavator. Due to this restricting device 6, it is possible to prevent the cab 2 from being removed from the body frame 1, for example, even when the body rolls over, and to protect the cab 2. The restricting device 6 is formed using the stopper receiver 7 which is provided in the support frame 3 which is a constituent member of the swinging frame (the body frame) 1 and in which the through-hole 7a is formed at the center, the bolt (shaft) 9 of which the upper part is fixed to the bottom of the cab 2 with the cab-side supporting member 8 interposed and the intermediate part passes through the through-hole 7a of the stopper receiver 7, and the stopper 10 that is supported on the lower part of the bolt 9 so as to make contact with the periphery of the through-hole 7a of the stopper receiver 7 in a locking manner to restrict the displacement of the cab 2 when the cab 2 is displaced in a direction away from the swinging frame 1. A contacting surface of the stopper 10 contacting the stopper receiver 7 is formed as the spherical surface 10a.

Thus, when the cab 2 is about to be displaced in a direction away from the swinging frame 1 exceeding the allowable displacement amount, the stopper 10 is received in a state where the spherical surface 10a makes contact with the peripheral portion of the through-hole 7a of the stopper receiver 7 in a locking manner. In this case, since the contacting surface of the stopper 10 contacting the stopper receiver 7 is the spherical surface 10a even when the cab 2 is displaced in a state of being inclined with respect to the swinging frame 1, the stopper 10 makes contact with the peripheral portion of the through-hole 7a of the stopper receiver 7 without making biased contact. Due to this, even when the cab 2 is displaced in a state of being inclined with respect to the swinging frame 1, approximately the same contacting area as when the cab 2 is displaced in parallel with the swinging frame 1 can be secured between the stopper 10 and the stopper receiver 7. Thus, it is not necessary to increase the size of the stopper with the strength in the biased contact taken into consideration unlike the conventional disc-shaped stopper, and it is possible to secure the required strength even when the size of the stopper 10 is decreased. As a result, it is possible to decrease the size of the stopper 10 and the entire size of the restricting device 6, to reduce the cost, and to improve flexibility in the arrangement location of the restricting device 6. Due to this, it is possible to arrange the restricting device 6 in an appropriate location according to the shape of the swinging frame 1 and the cab 2 and the layout of various equipments mounted on the swinging frame 1.

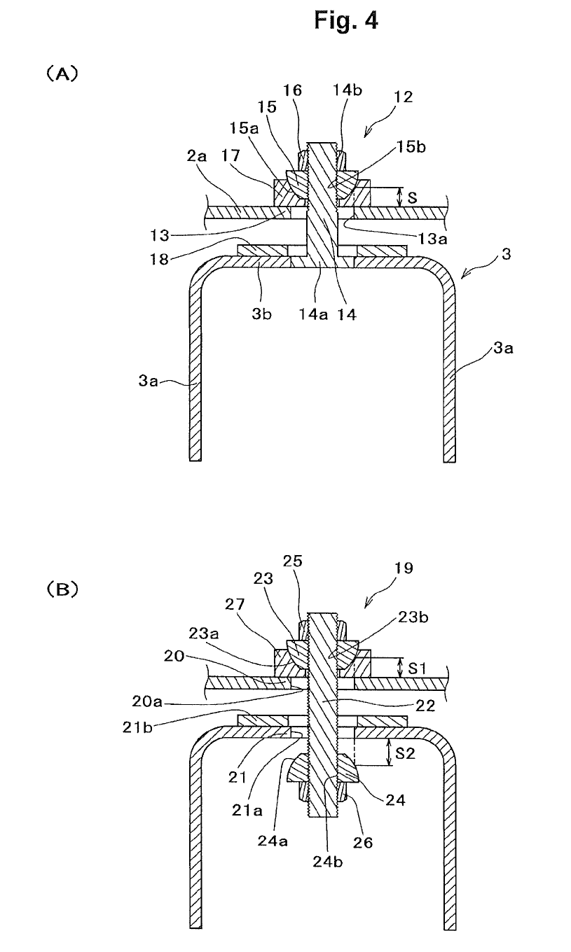

Next, second and third embodiments of the present invention will be described based on FIGS. 4A and 4B. In the second and third embodiment, the same (common) constituent components as those of the first embodiment will be denoted by the same reference numeral, and description thereof will not be provided.

First, the second embodiment illustrated in FIG. 4A will be described. A restricting device 12 of the second embodiment is formed using a stopper receiver 13, a bolt (corresponding to a shaft of the present invention) 14, and a stopper 15 similarly to the first embodiment. The stopper receiver 13 of the second embodiment is provided in the bottom (a lower frame or a bottom plate of the cab 2, and in FIG. 4A, the bottom plate 2a of the cab 2 is illustrated) of the cab 2, and a through-hole 13a is formed in the center of the stopper receiver 13.

Further, the bolt 14 of the second embodiment has a fixing unit 14a which is formed in the lower end in the axial direction and which is fixed to be integrated with the top plate 3b of the support frame 3 that forms the swinging frame 1 by welding or the like. An intermediate part of the bolt 14 of which the fixing unit 14a is fixed to the support frame 3 passes through the through-hole 13a of the stopper receiver 13 formed at the bottom of the cab 2, and the stopper 15 is supported on a thread portion 14b in the upper part of the bolt 14 having passed through the through-hole 13a.

The stopper 15 of the second embodiment has such a hemispherical trapezoidal shape that a spherical surface 15a faces downward and the diameter of an upper surface is larger than the diameter of the through-hole 13a of the stopper receiver 13, and a screw hole 15b that engages with the thread portion 14b of the bolt 14 is formed in a shaft core thereof. The stopper 15 is supported on the upper part of the bolt 14 in an aligned manner in a double nut locking state by a nut 16 that engages with the bolt 14 from the upper side of the stopper 15 in a state where the stopper 15 engages with the upper part of the bolt 14. Further, in this state, a gap S is formed between the upper surface of the stopper receiver 13 and a position at which an imaginary line drawn upward from the through-hole 13a of the stopper receiver 13 reaches the spherical surface 15a of the stopper 15. Due to this, when the cab 2 is about to be displaced in a direction away from the swinging frame 1 exceeding the gap S, the stopper 15 is received in a state of making contact, from the upper side, with the stopper receiver 13 provided on the bottom of the cab 2 in a locking manner. In this way, the displacement of the cab 2 is restricted. In FIG. 4A, a cushion member 17 such as a cushion rubber is disposed between the upper surface of the stopper receiver 13 and the stopper 15, and a reinforcing plate 18 is fixed to the peripheral portion of the bolt fixing unit 14a of the support frame 3.

In the second embodiment, the stopper receiver 13 is provided on the bottom of the cab 2, the bolt (shaft) 14 has the lower part fixed to the support frame 3 which is a constituent member of the swinging frame (body frame) 1 and the intermediate part that passes through the through-hole 13a of the stopper receiver 13, and the stopper 15 is supported on the upper part of the bolt 14 having passed through the through-hole 13a. In the second embodiment, the contacting surface of the stopper 15 contacting the stopper receiver 13 is formed as the spherical surface 15a. Thus, even when the cab 2 is displaced in a state of being inclined with respect to the swinging frame 1, the spherical surface 15a of the stopper 15 makes contact with the periphery of the through-hole 13a of the stopper receiver 13 without making biased contact. As a result, the second embodiment provides the same advantages as the first embodiment, and it is possible to decrease the size of the stopper 15 and the entire size of the restricting device 12.

Next, the third embodiment illustrated in FIG. 4B will be described. A restricting device 19 of the third embodiment is formed using stopper receivers 20 and 21, a bolt (corresponding to a shaft of the present invention) 22, and stoppers 23 and 24 similarly to the first and second embodiments. In the third embodiment, the stopper receiver includes the cab-side stopper receiver 20 provided on the bottom (a lower frame or a bottom plate of the cab 2, and in FIG. 4B, the bottom plate 2a of the cab 2 is illustrated) of the cab 2 and the body frame-side stopper receiver 21 provided in the support frame 3 which is a constituent member of the swinging frame (body frame) 1. The cab-side stopper receiver 20 and the body frame-side stopper receiver 21 face each other with a gap in the up-down direction. Through-holes 20a and 21a extending in the same axial direction are formed in the central portion of the cab-side stopper receiver 20 and the body frame-side stopper receiver 21.

Further, the bolt 22 of the third embodiment is a long bolt in which a thread is formed along the entire length, an intermediate part of the bolt 22 passes through the through-holes 20a and 21a of the cab-side stopper receiver 20 and the body frame-side stopper receiver 21, an upper stopper 23 is supported on the upper part of the bolt 22 having passed through the through-holes 20a and 21a, and a lower stopper 24 is supported on the lower part of the bolt 22.

The upper stopper 23 has such a hemispherical trapezoidal shape that the spherical surface 23a faces downward and the diameter of the upper surface is larger than the diameter of the through-hole 20a of the cab-side stopper receiver 20, and a screw hole 23b that engages with the bolt 22 is formed in a shaft core thereof. Moreover, the lower stopper 24 has such a hemispherical trapezoidal shape that the spherical surface 24a faces upward and the diameter of the lower surface is larger than the diameter of the through-hole 21a of the body frame-side stopper receiver 21, and a screw hole 24b that engages with the bolt 22 is formed in a shaft core thereof. The upper stopper 23 is supported on the upper part of the bolt 22 in an aligned manner in a double nut locking state by an upper nut 25 that engages with the bolt 22 from the upper side of the upper stopper 23 in a state where the upper stopper 23 engages with the upper part of the bolt 22. Moreover, the lower stopper 24 is supported on the lower part of the bolt 22 in an aligned manner in a double nut locking state by a lower nut 26 that engages with the bolt 22 from the lower side of the lower stopper 24 in a state where the lower stopper 24 engages with the lower part of the bolt 22. Further, in this state, an upper gap S1 is formed between the upper surface of the cab-side stopper receiver 20 and a position at which an imaginary line drawn upward from the through-hole 20a of the cab-side stopper receiver 20 reaches the spherical surface 23a of the upper stopper 23. Moreover, a lower gap S2 is formed between the upper surface of the cab-side stopper receiver 20 and a position at which an imaginary line drawn downward from the through-hole 21a of the body frame-side stopper receiver 21 reaches the spherical surface 24a of the lower stopper 24. When the cab 2 is about to be displaced in a direction away from the swinging frame 1 exceeding the sum of the upper gap S1 and the lower gap S2, the upper stopper 23 and the lower stopper 24 are received in a state of making contact with the cab-side stopper receiver 20 and the body frame-side stopper receiver 21 from the upper and lower sides, respectively; with displacement of the cab 2. In this way, the displacement of the cab 2 is restricted. In FIG. 4B, a cushion member 27 such as a cushion rubber is disposed between the upper surface of the cab-side stopper receiver 20 and the upper stopper 23, and a reinforcing plate 21b is fixed to the peripheral portion of the through-hole 21a of the body frame-side stopper receiver 21.

In the third embodiment, the cab-side stopper receiver 20 and the body frame-side stopper receiver 21 that face each other with a gap in the up-down direction are provided as the stopper receiver, the bolt (shaft) 22 has the intermediate part that passes through the through-holes 20a and 21a of the cab-side stopper receiver 20 and the body frame-side stopper receiver 21, and the upper stopper 23 and the lower stopper 24 are supported on the upper and lower parts of the bolt 22 having passed through the through-holes 20a and 21a. In the third embodiment, the contacting surfaces of the upper stopper 23 and the lower stopper 24 contacting the cab-side stopper receiver 20 and the body frame-side stopper receiver 21 are formed as the spherical surfaces 23a and 24a, respectively. Thus, even when the cab 2 is displaced in a state of being inclined with respect to the swinging frame 1, the spherical surfaces 23a and 24a of the upper stopper 23 and the lower stopper 24 make contact with the peripheral portions of the through-holes 20a and 21a of the cab-side stopper receiver 20 and the body frame-side stopper receiver 21 without making biased contact. As a result, the third embodiment provides the same advantages as the first and second embodiments, and it is possible to decrease the size of the stopper 15 and the entire size of the restricting device 12.

The present invention is not limited to the first to third embodiments, and for example, although the stopper 10 and the sleeve 11 are integrated with each other in the first embodiment, the stopper 10 and the sleeve 11 may be formed as separate members. Moreover, although the stopper receiver is provided on the support frame that forms the swinging frame in the first and third embodiments, the stopper receiver may not be a constituent member of the swinging frame but may be provided in a member that is fixed integrally with the swinging frame. Further, although the stopper has a hemispherical trapezoidal shape in the first to third embodiments, the stopper may have a hemispherical shape or a spherical shape, and in any case, it is sufficient that the contacting surface of the stopper contacting the stopper receiver is formed as a spherical surface. Further, the present invention can naturally be applied to various working machines such as a crane or a wheel loader as well as the excavator.

### INDUSTRIAL APPLICABILITY

The present invention can be applied to a working machine such as an excavator having a cab in which a restricting device for restricting the cab from being displaced from the body frame is provided.

### EXPLANATION OF REFERENCE NUMERALS

1: Swinging frame

2: Cab

3: Support frame

5: Antivibration mount

6: Restricting device

7: Stopper receiver

7a: Through-hole

9: Bolt (Shaft)

10: Stopper

10a: Spherical surface

12: Restricting device

13: Stopper receiver

13a: Through-hole

14: Bolt

15: Stopper

15a: Spherical surface

19: Restricting device

20: Cab-side stopper receiver

20a: Through-hole

21: Body frame-side stopper receiver

21a: Through-hole

22: Bolt

23: Upper stopper

23a: Spherical surface

24: Lower stopper

24a: Spherical surface

1. A cab protection device for a working machine in which a cab is attached to and mounted on an upper side of a body frame, with an antivibration mount interposed between the cab and body frame, wherein
a restricting device for restricting the cab from being displaced in a direction away from the body frame is formed with a stopper receiver which is provided on the body frame or/and a bottom of the cab and in which a through-hole is formed in a center thereof, a shaft that passes through the through-hole of the stopper receiver, and a stopper that is supported on the shaft so as to make contact with a peripheral portion of the through-hole of the stopper receiver in a locking manner to thereby restrict displacement of the cab when the cab is displaced in a direction away from the body frame, and
a contacting surface of the stopper contacting the stopper receiver is formed as a spherical surface.

2. The cab protection device for a working machine according to claim 1, wherein
the stopper receiver is provided on the body frame, and
the shaft has an upper part fixed to the bottom of the cab, an intermediate part that passes through the through-hole of the stopper receiver, and a lower part on which the stopper is supported.

3. The cab protection device for a working machine according to claim 1, wherein
the stopper receiver is provided on the bottom of the cab, and
the shaft has a lower part fixed to the body frame, the intermediate part that passes through the through-hole of the stopper receiver, and an upper part on which the stopper is supported.

4. The cab protection device for a working machine according to claim 1, wherein
the stopper receiver is provided on the bottom of the cab and the body frame, with a cab-side stopper receiver and a body frame-side stopper receiver being faced each other with a gap therebetween in an up-down direction, and
the shaft has an intermediate part that passes through through-hoes of the cab-side stopper receiver and the body frame-side stopper receiver, and upper and lower parts on which the stopper is supported.

5. A working machine including the cab protection device according to claim 1.
